(19) United States
(12) Patent Application Publication
(10) Pub. No.: US 2023/0040787 A1
(43) Pub. Date: Feb. 9, 2023

(54) METHOD, DEVICE, AND SYSTEM TO CONTROL STOPPING OF A MOBILITY DEVICE

(71) Applicants: HYUNDAI MOTOR COMPANY, Seoul (KR); KIA CORPORATION, Seoul (KR)

(72) Inventors: Jae Jun Ha, Hwaseong-si (KR); Young Jun Moon, Sejong-si (KR)

(73) Assignees: HYUNDAI MOTOR COMPANY, Seoul (KR); KIA CORPORATION, Seoul (KR)

(21) Appl. No.: 17/862,033

(22) Filed: Jul. 11, 2022

(30) Foreign Application Priority Data
Aug. 9, 2021 (KR) 10-2021-0104267

(51) Int. Cl. G08G 1/0968; G08G 1/123; G08G 1/01; G06Q 50/30

(52) U.S. Cl. CPC G08G 1/096838; G08G 1/123; G08G 1/0129; G06Q 50/30

(57) ABSTRACT

Disclosed are a method, device, and system to control stopping of a mobility device. In particular, the method includes: receiving a stop change request of a route mobility device from a user device; determining whether the stop change request satisfies a change condition; determining a change stop of the route mobility device based on the stop change request when the change condition is satisfied; and transmitting a change stop message to the route mobility device and at least one of the user device or a mobility device used by a user.

### CROSS-REFERENCE TO RELATED APPLICATIONS

This application claims priority to and the benefit of Korean Patent Application No. 10-2021-0104267, filed on Aug. 9, 2021, the entire contents of which are incorporated herein by reference.

### TECHNICAL FIELD

The present disclosure relates to a method, device, and system to control stopping of a mobility device so as to efficiently control stopping of the mobility device at a transfer station where various mobility devices stop using a stop control management system implemented by a computing device.

### BACKGROUND

The statements in this section merely provide background information related to the present disclosure and may not constitute prior art.

Public transportation services such as route buses, subways, autonomous shuttles or bus rapid transits (BRTs) are widely available and thus people may move to a destination without owning their cars. Furthermore, with development of technology, the concept of vehicle ownership has been weakened and use of shared mobility devices has increased. Specifically, vehicles or devices are shared in a specific area or residence for convenience of life, and the need to receive services using them is increasing.

Accordingly, transportation consumers may arrive at their destinations without walking by using a mixture of public transportation and a shared mobility device, which is recently spreading according to the first and last mile trend. To this end, we have discovered that it is desired to establish a system for linkage between stations of public transportation and shared mobility devices. Such a system may provide various linkage information to users based on data such as public transportation information and use information of a shared mobility device (referred to as shared mobility use information). Such linkage information may contribute to controlling operation and management of various mobility devices passing through and stored in stations. However, at the present time, platforms of public transportations and shared mobility devices are separately operated and thus there is no integration of information on linkage between them. Therefore, there is no system for controlling operation and management of mobility devices or vehicles in stations.

### SUMMARY

The present disclosure provide a method, device, and system to control stopping of a mobility device that efficiently controls the stopping of the mobility device at a transfer station where various mobility devices stop using a stop control management system implemented by a computing device.

The technical objects of the present disclosure are not limited to the above technical problems and other technical problems which are not described herein should be clearly understood by a person (hereinafter referred to as an ordinary technician) having ordinary skill in the technical field, to which the present disclosure belongs, from the following description.

According to one embodiment of the present disclosure, a method for a stop control management system to control stopping of a mobility device is implemented by a computing device. The method comprising: receiving a stop change request of a route mobility device from a user device; determining whether the stop change request satisfies a change condition; determining a change stop of the route mobility device based on the stop change request when the change condition is satisfied; and transmitting a change stop message to the route mobility device and at least one of the user device or a mobility device used by a user.

According to one embodiment of the present disclosure, the stop change request may be generated based on at least one of getting-on/off designation information of a getting-on/off stop received from a user device of a person scheduled to get on/off the route mobility device, transfer information of a transfer route mobility device received from the user device or shared mobility use information received from the user device.

According to another embodiment of the present disclosure, determining whether the stop change request may satisfy the change condition comprises: determining that the change condition is satisfied when the stop change request is equal to or greater than a predetermined ratio of the number of people included in information on the number of people scheduled to get on/off the route mobility device.

According to another embodiment of the present disclosure, the number of people may be calculated based on a getting-on/off request of a regular stop received from at least one of the user device or a reception device which receives a getting-on/off request in a mobility transfer hub, in which the route mobility device stops, and the change request.

According to the embodiment of the present disclosure, whether the stop change request is equal to or greater than the predetermined ratio may be determined based on the change request, an allowance response message of a change stop from a user device without the change request and the number of people scheduled to get on and off the mobility device (e.g., a mobility vehicle).

According to the embodiment of the present disclosure, determining the change stop may comprise determining any one of a preset dynamic stop adjacent to a requested change stop or a dynamic stop adaptively selected for a plurality of requested change stops, based on change stop information in the change request.

According to one embodiment of the present disclosure, determining the dynamic stop between the plurality of requested change stops may comprise determining the dynamic stop between the change stops by generating change group information by grouping a plurality of change stops within a predetermined distance range and applying a weight which gradually decreases from change group information of a maximum request to change group information of a minimum request.

According to one embodiment of the present disclosure, the change stop may be determined to be a dynamic stop adjacent to a regular stop of the route mobility device among the dynamic stops.

According to one embodiment of the present disclosure, determining the change stop may comprise: determining a potential change stop based on the change request, obtaining mobility stopping information at the potential change stop, and determining the potential change stop as a final change stop based on a congestion level of the potential change stop according to the mobility stopping information.

According to one embodiment of the present disclosure , determining the potential change stop as the final change stop may comprise: selecting a plurality of candidate stops and obtaining mobility stopping information of the candidate stops, when the congestion level of the potential change stop is equal to or greater than a first congestion threshold, and determining any one of the plurality of candidate stops as the final change step, based on distances between the potential change stop and the candidate stops and congestion levels of the candidate stops, when the congestion levels of the candidate stops according to the mobility stopping information are equal to or less than a second congestion threshold.

According to one embodiment of the present disclosure, determining the change stop may comprise: maintaining a change stop of the route mobility device having a maximum number of people based on information on the number of people scheduled to get on/off each route mobility device, when change stops of a plurality of route mobility devices are the same, and re-determining a change stop of next-ranked route mobility device in the number of people.

According to one embodiment of the present disclosure, determining the change stop may comprises: determining a final change stop based on a scheduled departure time of the preceding mobility device, a scheduled arrival time of the subsequent mobility device and preceding and subsequent change stops according to the change request, when different stop change requests of preceding and subsequent route mobility devices using the same regular stop are received.

According to one embodiment of the present disclosure, the final change stop may be determined such that the change stops of the preceding and subsequent route mobility devices are the same, when an interval between the scheduled departure and arrival times is within a predetermined time and a distance between the preceding and subsequent change stops is within a predetermined value.

According to one embodiment of the present disclosure, after transmitting the change stop message, the method may further comprise: analyzing history information of the change stop and use information of people who get on/off the route mobility device for each time zone, and determining a new stop based on existing stop data when there is a correlation between the history information and the use information of the people who get on/off the mobility device.

According to one embodiment of the present disclosure, after transmitting the change stop message, the method may further comprise: performing a control such that a shared mobility device is returned to the change stop, when a scheduled arrival time between the route mobility device and the shared mobility device is within a predetermined time.

According to another embodiment of the present disclosure, a server for controlling a stop of a mobility device comprises: a transceiver configured to transmit and receive a signal; and a processor configured to control the transceiver. The server is configured to: receive a stop change request of a route mobility device from a user device; determine whether the stop change request satisfies a change condition; determine a change stop of the route mobility device based on the stop change request when the change condition is satisfied; and transmit a change stop message to the route mobility device and at least one of the user device or a mobility device used by a user.

According to another embodiment of the present disclosure, there is provided a management system implemented by a computing device to perform a mobility stop control process. The management system comprising: a server configured to operate the management system; at least one user device registered in the management system; and at least one route mobility device registered in the management system. The server is configured to: receive a stop change request of a route mobility device from a user device; determine whether the stop change request satisfies a change condition; determine a change stop of the route mobility device based on the stop change request when the change condition is satisfied; and transmit a change stop message to the route mobility device and at least one of the user device or a mobility device used by a user.

According to the present disclosure, it is possible to provide a method, device, and system for controlling a stop of a mobility device, that efficiently controls the stop of the mobility device at a transfer station where various mobility devices stop using a stop control management system implemented by a computing device

It should be appreciated by persons having ordinary skill in the art that that the effects that can be achieved through the present disclosure are not limited to what has been particularly described hereinabove and other advantages of the present disclosure should be more clearly understood from the detailed description.

### BRIEF DESCRIPTION OF THE DRAWINGS

In order that the disclosure may be well understood, there will now be described various forms thereof, given by way of example, reference being made to the accompanying drawings, in which:

FIG. 1 is a view illustrating a mobility device and a user device performing communication with another device through a network;

FIG. 2 is a view illustrating management and control of a mobility device based on a management system;

FIG. 3 is a view illustrating management of a user device based on a management system;

FIG. 4 is a view illustrating an example of a mobility transfer hub and a change stop;

FIG. 5 is a flowchart illustrating a method of controlling a stop of a mobility device according to an embodiment of the present disclosure;

FIG. 6 is a flowchart illustrating a first detailed embodiment in a stop control method;

FIG. 7 is a flowchart illustrating a second detailed embodiment in a stop control method;

FIG. 8 is a flowchart illustrating a third detailed embodiment in a stop control method;

FIG. 9 is a flowchart illustrating a fourth detailed embodiment in a stop control method;

FIG. 10 is a flowchart illustrating control of a stop of preceding and subsequent route mobility devices stopping at the same regular stop;

FIG. 11 is a flowchart illustrating determination of a stop based on history information of a change stop and user information of a route mobility device;

FIG. 12 is a flowchart illustrating determination of a return place of a shared mobility device based on stop information of a route mobility; and

FIG. 13 is a diagram illustrating the configuration of a device according to an embodiment of the present disclosure.

The drawings described herein are for illustration purposes only and are not intended to limit the scope of the present disclosure in any way.

### DETAILED DESCRIPTION

Hereinafter, exemplary embodiments of the present disclosure are described in detail with reference to the accompanying drawings so that those having ordinary skill in the art may easily implement the present disclosure. However, the present disclosure may be implemented in various different ways, and is not limited to the embodiments described therein.

In describing exemplary embodiments of the present disclosure, well-known functions or constructions are not be described in detail since they may unnecessarily obscure the understanding of the present disclosure. The same constituent elements in the drawings are denoted by the same reference numerals, and a repeated description of the same elements are omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them should become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure is complete and should fully convey the scope of the present disclosure to those having ordinary skill in the art.

When a component, device, element, or the like of the present disclosure is described as having a purpose or performing an operation, function, or the like, the component, device, or element should be considered herein as being “configured to” meet that purpose or to perform that operation or function.

Hereinafter, embodiments of the present disclosure are described with reference to the accompanying drawings.

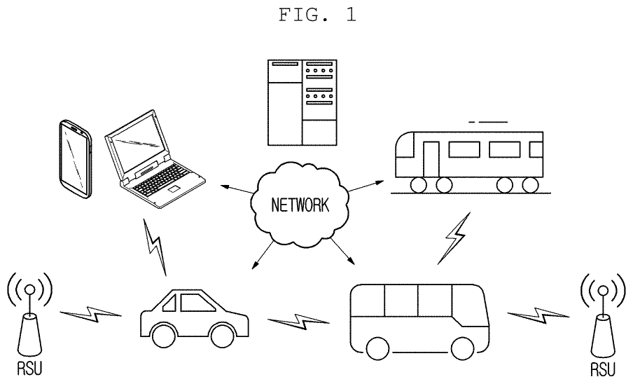

FIG. 1 is a view illustrating a mobility device and a user device performing communication with another device through a network.

Referring to FIG. 1, a mobility device may perform communication with another mobility device or another device. The mobility device may refer to a device capable of moving as a means for transporting a user. The mobility device may include, for example, a route mobility device or a shared mobility device. The route mobility device may be a mobility device which transports users along a static route passing through a designated stop or a dynamic route according to the requests of a plurality of users. The route mobility device may include, for example, a route bus, a subway, a BRT, a tram, a flying mobility device, an on-demand mobility device, but is not limited to the above-described examples. The flying mobility device is a means of flying in the air while taking off and landing at a predetermined base and may include a personal aerial vehicle (PAV) and an urban air mobility (UAM). The flying mobility device may fly along pre-designated bases or to a base selected by a user request. The flying mobility device may include a manned small flight vehicle or an unmanned or autonomous drone, but is not limited to the above-described examples. The on-demand mobility device may be a device for transporting a user while moving along a dynamic route generated according to the requests of a plurality of users. The on-demand mobility device may refer to a shuttle having a changeable route within a limited range while going around a basic route within in a certain area or a mobility device which moves by dynamically setting a route without limitation within a certain area.

The shared mobility device may include mobility devices owned by operation agency or an individual and provided to be available by other users. The shared mobility device may include, for example, various types of vehicles and micro-mobility devices. The vehicles may include sedans and cargo-loadable vehicles. The micro-mobility devices may include, for example, a micro-mobility device including at least three wheels for stable independent driving and micro-mobility device (e.g., a single-wheel Segway, a two-wheel Segway, an electric scooter, etc.) which may be independently driven by maintaining balance even if one or two wheels are provided. The micro-mobility device may use electricity using a battery as a power source, but is not limited thereto and any type of power source capable of moving a mobility device may be used. For example, the micro-mobility device may mean a movement device in which only one user rides or a movement device used by only one user. In addition, the micro-mobility device is a small movement device and may mean a movement device which may be used by a small number of users. For example, the micro-mobility devices may include not only single-wheel, two-wheel Segways and electric scooters but also electric wheelchairs, electric bicycles and electric two-wheel vehicles. In addition, the micro-mobility devices may include the other movement devices and are not limited to the above-described embodiment.

Meanwhile, the mobility device and the user device may perform communication with another mobility device, another device or an external server based on cellular communication, WAVE communication, dedicated short range communication (DSRC) or other communication. That is, as a cellular communication network, a communication network such as LTE or 5G, a Wi-Fi communication network, a WAVE communication network, etc. may be used. In addition, a short range communication network used in a mobility device, such as DSRC, may be used, but is not limited to the above-described embodiment.

In addition, for example, in relation to communication of the mobility device, a module capable of performing communication with a user device and a module capable of performing communication with an external server may be separated, for mobility security. For example, the mobility device may perform communication based on security for devices within a certain range of the mobility device, such as Bluetooth and NFC communication. For example, a mobility device and a user's privately owned device may include a communication module for performing only mutual communication. That is, the mobility device and the user's personal device may use a communication network disconnected from an external communication network. In addition, for example, the mobility device may include a communication module for performing communication with an external server. In addition, for example, the above-described module may be implemented by one module. That is, based on one module, the mobility device may perform communication with another device, but is not limited to the above-described embodiment. That is, in the mobility device, a communication method may be implemented based on various methods, and is not limited to the above-described embodiment.

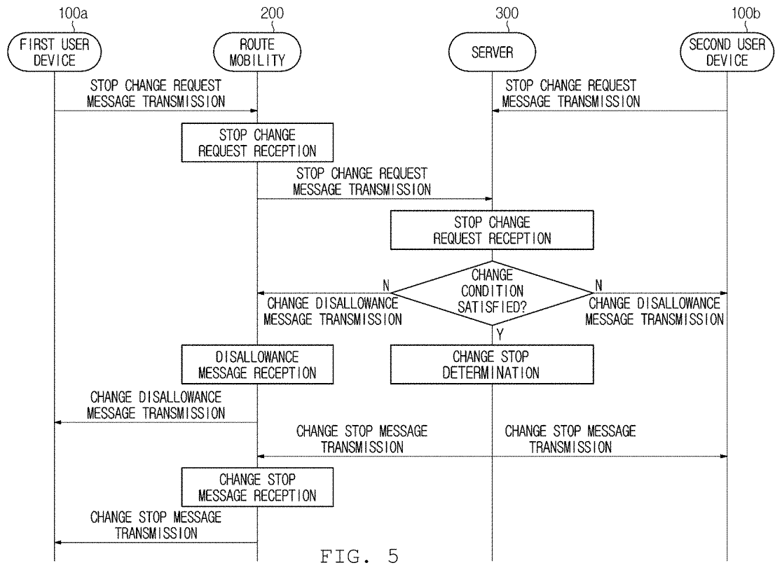

The user device may communicate with an external server. The external server may be, for example, a mobility management server for mobility use, a route server for guiding a route to a destination or a mobility transfer hub server for managing a mobility transfer hub (hereinafter referred to as a “transfer hub”). The user device may be connected to the external server in a space spaced apart from a transfer hub or a mobility device in which a user rides. As another example, when the user device enters a predetermined range from the transfer hub, connection with the transfer hub server may be activated to exchange data. When there is a request for use of a mobility device in the transfer hub from the user device, the request for use may be transmitted to a mobility management server and simultaneously transmitted to the transfer hub server. When a route to a destination requested by the user device from a route server includes a transfer hub, the route request of the user device may be transmitted to the transfer hub server. Although, in the above description, the mobility management server and the transfer hub server are described as being separate devices, one server may be implemented to perform use of the mobility device and management of the transfer hub in another example. As another example, the mobility management server may provide a service to use a mobility device and implement control related to stopping a mobility device and return in the transfer hub. The mobility management server may receive a stop change request of a mobility device from a user device and a reception device and determine a change stop matching the change request based on geographical information of the transfer hub obtained from the outside. Although a transfer hub server (that is, a server 300 of FIG. 5) is described as processing a stop change request for convenience of description, the mobility management server may perform the following embodiments of the present disclosure.

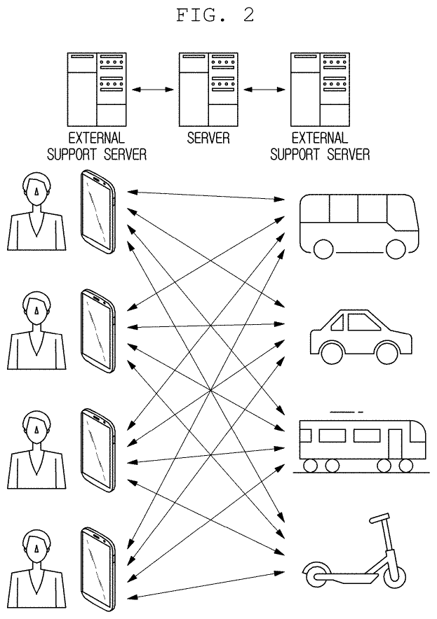

FIG. 2 is a view illustrating management and control of a mobility device by a management system.

For example, a management system is applicable in order to provide management and stopping of a mobility device which uses a transfer hub and a transfer service of a user. The management system may be operated by generating, processing and exchanging data between computing devices. The management system may include, for example, at least one server, a plurality of user devices and various types of mobility devices. The management system may perform control to change a stop according to a request of a user device and control and manage stopping and parking of a mobility device which stops at a regular stop of the transfer hub or returns to a shared mobility area even if there is not change. That is, the management system may be used as a stop control management system which implements the above-described functions and may provide various services in the transfer hub. In the present disclosure, the function of the stop control management system is focused upon, but the management system may implement all various services and control of a stop. Hereinafter, for convenience of description, the management system is described.

The server may manage hub use information, state information, riding information, arrival/departure time information and route information of a mobility device related to use of the transfer hub in the case of the route mobility, the on-demand mobility device and the flying mobility device. The server may provide the mobility device with a message for controlling entry/exit, stopping point, departure point and getting-on/-off state in the transfer hub based on the above-described information. The server may provide the user device with the getting-on/off area of the route mobility device and the on-demand mobility device, a scheduled departure/arrival time and a movement route to the corresponding area based on the above-described information.

In the case of the shared mobility device, the server may receive use status information of a shared mobility device in a sharing area located around the transfer hub and provide the mobility device or the user device with a message inducing rental or return in the area. In addition, the server may receive the use status information of the shared mobility device and manage the shared mobility device according to a message transmitted from another server for processing the request of the user device for a sharing service. As another example, the server may not only manage the transfer hub but also provide a sharing service for a sharing area around the transfer hub. Accordingly, the server may directly receive a request for use of a shared mobility from a user device and perform overall management such as assignment, return, authentication and maintenance of the shared mobility device. The server may provide the user device with the rental area of the shared mobility device and a movement route to the corresponding area, based on location information of the sharing area and the shared mobility device and the use status information.

When the server provides a sharing service, the shared mobility device may be authenticated and authorized to be shared by the management system. For example, the shared mobility device may be a vehicle and/or a micro-mobility device registered in the management system. In this case, a system administrator may provide the shared mobility device for the management system. That is, only the vehicle or the micro-mobility device authenticated or authorized by the system administrator may be used as a shared mobility device. Accordingly, it is possible to prevent accidents that may occur by security or management of the shared vehicle and the shared micro-mobility device in the management system. More specifically, mobility devices to be shared may be registered in the management system. The rights to register the shared mobility device in the management system may be restricted by the management system. In this case, shared mobility devices, which may be registered in the management system, may have the same ID or the same identification information. In addition, since the management system provides the shared mobility device, management of the shared mobility device may be performed. For example, management of the shared mobility device may be information necessary to provide the sharing service, such as the state information or operation information of the shared mobility device registered in the management system. In this case, the management system may check the state of the shared mobility device in real time, control rights to use or transmit a command for repair through the system with respect to the shared mobility device in which a problem has occurred, and provide maintenance based on this.

Meanwhile, the management system may include a plurality of devices and a plurality of mobility devices. In addition, for example, the management system may further include a road side unit (RSU). In this case, the device may include a smartphone, a smart pad, a smart watch, etc. As another example, the device may refer to a device capable of exchanging signals by performing other communication and is not limited to the above-described embodiment. As another example, the RSU may be a device capable of communication as a road side unit. In addition, for example, the RSU may refer to a structure installed to transmit and receive a signal to a building or the other area and is not limited to the above-described embodiment. However, hereinafter, for convenience of description, this is collectively referred to as an RSU, may include various structures or devices and is not limited to the above-described embodiment.

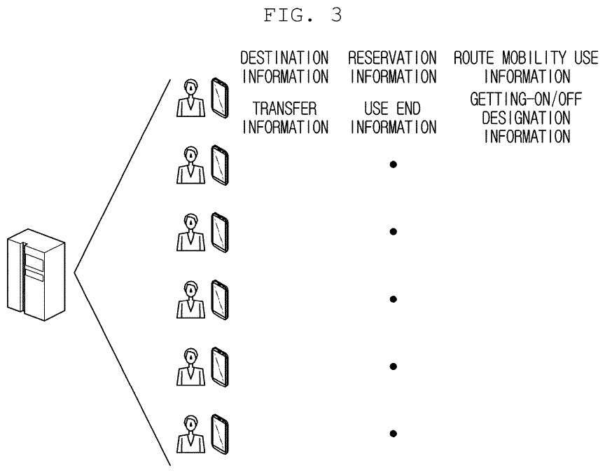

FIG. 3 is a view illustrating management of a user device based on a management system.

In the management system, user devices may be managed. In this case, for example, in the management system, information of each user may be managed. For example, user information may include information on use of the transfer hub by the user based on a user ID or the identification device of the user. As a more specific example, the information of each user may include at least one of route information, shared mobility use information, use information of route mobility device (referred to as route mobility use information) or getting-on/off designation information.

The route information may be input through the user device and transmitted to the server. The route information may be determined from departure point and destination information received from the user device. The route information may include not only at least one geographic route from a departure point to a destination but also at least one of available mobility information related to an available route/shared mobility device on the geographic route or transfer information of the user between different mobility devices. The user may select available mobility information on the route or transfer information of the mobility device scheduled or requested in the transfer hub through an application implemented in the user device. The transfer information may be information on scheduled transfer of the user and may include transfer hub information between different mobility devices along with available mobility information related to route and shared mobility devices to be linked or different route mobility devices to be linked. In addition, the transfer information is a user request for transfer and may include a use request or reservation information of a mobility device for transfer in the transfer hub, such as a platform mobility device, or a route mobility device. When the user uses a mobility device according to the route information or when an event intending to use a mobility device is detected, the route information may be transmitted to the server to estimate use of the mobility device in the transfer hub. The use intention event may be detected, for example, based on actual movement information based on the location information of the user device, use of the mobility device provided by available mobility information, mobility use request and reservation or activity information of the user who uses the user device, such as inquiry and search of the mobility device in the transfer hub.

The shared mobility use information may be based on assignment, return request, reservation information and use end information of the user for the shared mobility device provided in the shared mobility area around the transfer hub and use state information of the user who is using the shared mobility device. The use state information may include location information, driving information, fuel/battery remaining amount information, failure information, maintenance information, etc. of the shared mobility device used by the user who has set the transfer hub as an arrival point. The shared mobility use information may be transmitted from the user device or the mobility management server.

The route mobility use information may include user information related to use, getting-on/off and use history of a route mobility device stopping in the transfer hub. The route mobility use information may be generated from, for example, a message of a user device which is riding in the route mobility device or has requested to get on or off the route mobility device in the transfer hub. In addition, the route mobility use information may be generated from a message of a user device which has requested at least one of reservation for use of the route mobility device or reservation for transfer to another mobility device in the transfer hub. In addition, the route mobility use information may include history information of a route mobility device and a transfer mobility device which have been used by the user in the transfer hub and history information of a user for the route mobility device stopping in the transfer hub.

The getting-on/off designation information may be related to a getting-on/off point of the user, which is changed, designated or accumulated, for the getting-on/off point of the route mobility device in the transfer hub. The getting-on/off designation information may include, for example, stop change requested by the user when getting on/off the route mobility device, dynamic stop designation information, a stop of a user who gets on/off a route mobility device which has entered the transfer hub, and a getting-on/off point of the user for each route mobility device, which was accumulated in the past in the transfer hub.

The above-described various information may be received and managed by a server for controlling the management system, when the user is estimated to enter the transfer hub based on the user device and the location information of the route mobility device. As another example, at least some of the above-described information may be stored in a user capable of communicating with the system in the mobility device.

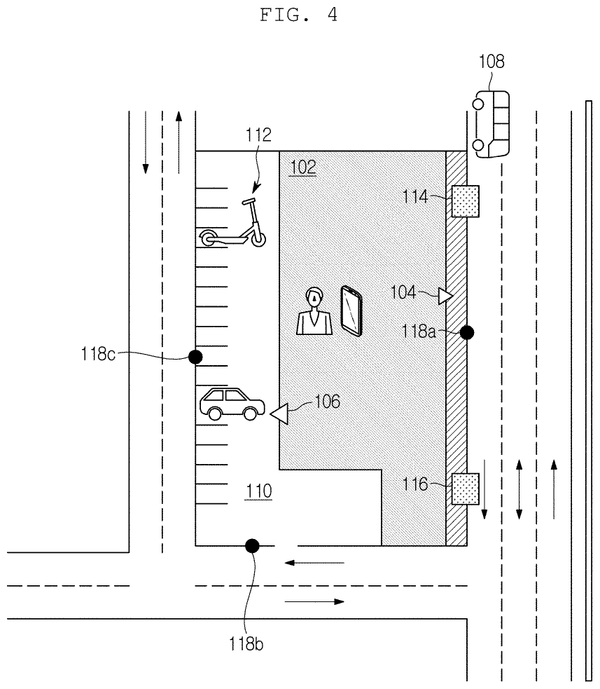

FIG. 4 is a view illustrating an example of a mobility transfer hub and a change stop.

A mobility transfer hub 102 may be a space including a linkage area in which various mobility devices may stop and enable transfer or connection with surrounding facilities may be established. The linkage area may include a hub platform for a platform mobility device entering and stopping in the transfer hub 102 and mobility transfer areas 110, 112, 114 and 116 for route/shared mobility device, which are provided adjacent to the hub 102 to be linked to the platform mobility device or another route/shared mobility device. In addition, the linkage area may further include a surrounding facility area including at least one of residential or commercial buildings other than transportation facilities. In the mobility transfer hub 102, a plurality of entrances 104 and 106 for enabling users to move to any one of the hub platform or the linkage area may be disposed.

The platform mobility device using the hub platform may be a transportation device which employs the transfer hub 102 as a stop or destination and is authorized or controlled by a server (see 200 of FIG. 5) for controlling the transfer hub 102 for entry into (stopping in) the transfer hub 102, departure or waiting. The platform mobility device may be, for example, a subway, a wide-area train, a bus, a tram, a BRT, or a flying object. The flying object may be a long-distance aircraft, a shuttle aircraft or an urban air mobility (UAM) provided only in a predetermined area, a small personal aircraft or a small aircraft exclusively provided to specific users.

When the platform mobility device regularly stops at the hub platform, the server 300 may receive scheduling information related to entry and exit in the transfer hub 102 from the mobility management server for performing overall control such as allocation, scheduling or operation status of the platform mobility device, and control entry and exit, waiting and stopping point assignment of the platform mobility device in the hub platform. As another example, the server 300 may receive, from the platform mobility management server, reservation information of a passenger, who gets on or off, in the transfer hub 102 or actual user information of the mobility device, and receive, from a route/shared mobility management server, use request or reservation information of the mobility device in the transfer hub 102. The server 300 may estimate transfer demand information of each mobility device in the transfer hub 102 based on the above-described information. As another example, when the platform mobility device approaches the transfer hub 102 within a predetermined distance, the server 300 may receive the use request or reservation information and, at the same time, receive the actual user information of the mobility device from at least one of the platform mobility management server or the platform mobility device and estimate the transfer demand information of each mobility device.

When the platform mobility device irregularly stops at the hub platform, the mobility management server may transmit scheduled arrival time information of the mobility device or actual user information to the server 300 along with a scheduled use message of the transfer hub 102 by the platform mobility device. As another example, when the platform mobility device approaches the transfer hub 102 within a predetermined distance range, the server 300 may receive the scheduled arrival time information of the mobility device and actual user information from at least one of the platform mobility management server or the platform mobility device. Even in the irregular platform mobility, the server 300 may receive the use request or reservation information from the route/shared mobility management server and estimate transfer demand information of each mobility device based on the above-described information.

The route mobility device 108 may be a movement device which provides a movement service to the user through the regular stops 114 and 116 uniquely assigned to certain points in the hub 102 or around the transfer hub 102 and is subjected to relatively relaxed control from the server 300 compared to the platform mobility device. A second mobility device subjected to the relaxed control may not be, in principle, authorized by the server 300 of the transfer hub 102 to stop or park at the regular stops 114 and 116. In the present disclosure, by the stop change request of a person who gets on/off the route mobility device 108, transfer information of the user and reservation information of the shared mobility device, the server 300 may dynamically change the stop to perform control such that the route mobility device 108 stops at the change stop. Information related to operation and use status of the route mobility device 108, a user request for the route mobility device 108, and processing according thereto may be controlled and managed by the route mobility management server. The route mobility management server may provide the departure/arrival time information at the transfer hub 102 of the route mobility device 108 and the stop information, in response to the request of the server 300. In addition, the server 300 may transmit information related to stop change to the route mobility management server when performing control such that the route mobility device 108 stops at the change stop.

The shared mobility device may be accommodated in shared mobility areas 110 and 112 located at a certain point in the hub 102 or around the transfer hub 102, in order to provide the sharing service to the user. In the present disclosure, when the user of the route mobility device 108 reserves the shared mobility device and the stop of the route mobility device 108 is changed, the server 300 may perform control such that the shared mobility stops at the change stops 118a, 118b and 118c, instead of the shared mobility areas 110 and 112. Information related to operation and use status of the route mobility device, a user request for the route mobility device, and processing according thereto may be controlled and managed by the shared mobility management server. The shared mobility management server may provide rental/return information in the transfer hub 102 and status information such as the number of mobility devices capable of being parked in the transfer hub 102, in response to the request of the server 300. In addition, the server 300 may transmit information related to return place change and return processing to the shared mobility management server, when performing control to return the shared mobility device to the change stop.

FIG. 5 is a flowchart illustrating a method of controlling a stop of a mobility device according to an embodiment of the present disclosure.

FIG. 5 illustrates an example of a stop control method when a first user device 100a of a first user who gets on the route mobility device 108 requests change of a stop to get off and, at the same time, a second user device 100b of a second user who is scheduled to get on the route mobility device 108 requests to change a stop.

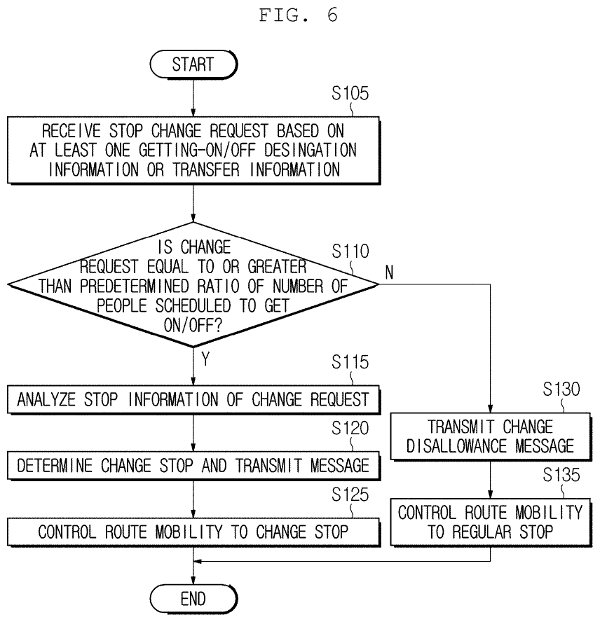

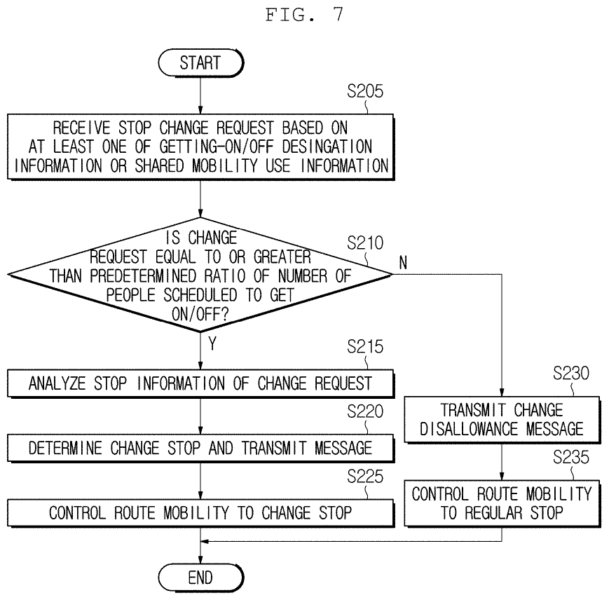

In a state in which the first user gets on the route mobility device 108 which is scheduled to stop at a first regular stop 114 of the transfer hub 102, the first user device 100a may transmit, to the route mobility device 108, a message requesting to change the first regular stop 114 to the other stops 104 and 106 to stop at the stops 104 and 106. The route mobility device 108 may transmit a message related to the received stop change request to the server 300. The regular stop may be a transfer area originally assigned such that the route mobility device 108 stops in the transfer hub 102. The stop change request may be generated from at least one of getting-on/off designation information, transfer information and shared mobility use information received from the first user device 100a. The stop change request is described in detail with reference to FIGS. 6 and 7. As another example, the message may be transmitted to a route mobility management server. However, in the present example, for convenience of description, it is assumed that the message is transmitted to the route mobility device 108.

In this regard, the server 300 may provide an application for a hub to the user devices 100a and 100b. The application for the hub may provide a user who uses the transfer hub 102 with at least information related to getting on/off the mobility device of the hub 102, map information of the transfer hub 102 and movement route information between transfer areas. The information related to getting on/off the mobility device may include, for example, departure/arrival time information of the platform mobility device and the route mobility device 108, stopping point information of the platform mobility device and the route mobility device 108, etc. The movement route information may provide a route through which the user reaches desired transfer areas 110 to 116 in the transfer hub 102 in a visual manner. The application for the hub may be connected to the management server of each mobility device used by the user according to the request of the server 300 to transmit and receive various information. In addition, as shown in FIG. 2, the application for the hub may communicate with an external application or an external support server to support movement of the user, thereby receiving user related information. When user information employing the transfer hub 102 as a destination or a stopover for transferring to another mobility device, such as transfer information and shared mobility use information, is generated, the application for the hub may be provided to the user devices 100a and 100b in a push form. In addition, when the application for the hub is already installed in the user devices 100a and 100b, the server 300 may activate the application in the user devices 100a and 100b when the user reaches a predetermined distance from the transfer hub 102. Hereinafter, for convenience of description, although the requests and responses of the user devices 100a and 100b, the server 300, the route mobility device 108 are described as being implemented through the application for the hub, but is not limited thereto and various methods which may be added to an application supporting services related to all mobility devices stopping in the transfer hub 102 may be realized.

Meanwhile, in a state in which a second user is located at the transfer hub 102 to get on the route mobility device 108 which is scheduled to stop at the first regular stop 114, the second user device 100b may transmit, to the server 300, a message requesting to change the first regular stop 114 to other stops 104 and 118b. The stop change request may be generated from at least one of getting-on/off designation information, transfer information or shared mobility use information received from the second user device 100b. The stop change request of the second user device 100b is described in detail below with reference to FIGS. 6 and 7. As another example, the second user may transmit the message using a reception device installed in the transfer hub 102 to provide the application for the hub. The reception device may be, for example, a kiosk, and kiosks may be installed at a plurality of places of the transfer areas 110 to 116 and the transfer hub 102, for user convenience. The kiosk may provide the user with departure/arrival information of the platform mobility device and the route mobility device and stopping point information, and the user may request use and reservation of various types of mobility devices stopping in the transfer hub 102 and stop change through the kiosk. Hereinafter, for convenience of description, if there is no special limitation, the user device owned by the user and the kiosk installed in the transfer hub 102 for common use is collectively referred to as a user device.

Next, the server 300 may determine whether the stop change requests received from the first and second user devices 100b satisfy a change condition. According to a result of responses transmitted by people scheduled to get on/off in the transfer hub 102 through the user devices 100a and 100b, the server 300 may determine whether the change condition is satisfied. Details thereof are described below with reference to FIGS. 6 and 7.

When the change condition is not satisfied, the server 300 may transmit a stop change disallowance message to the first and second user devices 100b and the route mobility device 108, and control the route mobility device 108 to stop at the first regular stop 114.

When the change condition is satisfied, the server 300 may analyze information on the requested change stops 104, 116 and 118b received from the user devices 100a and 100b, which have requested the change, and stop information of another route mobility device, and determine a change stop 118a corresponding to the plurality of requested change stops 104, 116 and 118b. Analysis of the stop information and determination of the change stop is described below with reference to FIGS. 6 to 10.

The server 300 may transmit a message including the location of the determined change stop to the route mobility device 108 and the user devices 100a and 100b of people scheduled to get on/off. The route mobility device 108 may be controlled to stop at the change stop 118a based on the change stop message. The user devices 100a and 100b, to which the message is be transmitted, may include not only devices which have requested to change the stop but also devices of people who have not requested to change the stop but are scheduled to get on/off. As another example, server 300 may transmit the change stop message to the route mobility device 108 and mobility device utilized by the user or other user. For instance, the mobility device may be shared mobility device or the user's own mobility device.

FIG. 6 is a flowchart illustrating a first detailed embodiment in a stop control method. FIG. 6 shows a detailed example related to the stop change request, the change condition and change stop determination of FIG. 5.

The first and second user devices 100b may transmit, to the route mobility device 108, a message requesting to change the first regular stop 114 to the other stops 104, 116 and 118b and to stop at the other stops 104, 116 and 118b, and the server 300 may receive a message related to the stop change request through the route mobility device 108 (S105).

The first user may transmit a message requesting to change to the other stops 104 and 115 using the first user device 100a in a state getting on the route mobility device 108, and the server 300 may receive the message from the first user device 100a. The stop change request may be generated from at least one of getting-on/off designation information or transfer information received from the first user device 100a.

A change request with a designated getting-off point may be generated, for example, by directly designating a specific point of the transfer hub 102, at which the first user device 100a desires to get off, instead of the first regular stop 114. For example, the first user device 100a may select a specific point on the map of the transfer hub 102 provided by the application for the hub as a requested change stop. The application may provide geographic information, in which the transfer hub 102 shown in FIG. 4 and surrounding facilities are arranged, in the form of a map. The application may be provided to select an arbitrary point around the transfer hub 102 shown in FIG. 4 as a request change stop or may provide only some surrounding points selectable by the first user.

The stop change request based on transfer information may be generated based on the transfer information received from the first user device 100a. The transfer information may be received from the first user device 100a, and may include at least one of a user request to use a transfer mobility device and a mobility device to transfer, which is estimated from a route to destination information, or reservation information. The stop change request may be set to designate a point close to an entrance for accessing the hub platform of the platform mobility device and the stop of the route mobility device as the request change stop, according to the type of the transfer mobility device. The point may be the entrance and a regular and final change stop of the route mobility device or a location close to the entrance and stop previously designated by the server 300.

In addition, the second user may transmit a message requesting change to the other stops 104 and 118b using the second user device 100b while waiting in the transfer hub 102, and the server 300 may receive the message from the second user device 100b. In this case, the stop change request may be generated from at least one of getting-on/off designation information or transfer information received from the second user device 100b.

A change request with a designated getting-on point may be generated, for example, by directly designating a specific point of the transfer hub 102, at which the second user device 100b desires to get on. The stop change request based on the transfer information may be generated based on the transfer information received from the second user device 100b. Setting of the requested change stop according to designation and transfer information may be substantially the same as the example of the first user device 100a.

Meanwhile, before the route mobility device 108 arrives at the first regular stop 114, the server 300 may provide a query message for inquiring whether to allow change of the stop to the user device which is getting on or is scheduled to get on the route mobility device 108 and the reception device of the transfer hub 102, such as the kiosk. The server 300 may identify the device which is scheduled to get on, based on the transfer information received from the first and second user devices 100b. The user may respond to the query message using the device. Specifically, the user device may transmit, to the server 300, a response to allow or disallow the change, in response to the query message. Additionally, the server 300 may receive a message related to the above-described stop change request, by inquiring of the user device which has respond to allow the change about whether to request change of the stop.

Next, the server 300 may determine whether the stop change request received from the first and second user devices 100b satisfies a change condition. In the present disclosure, the server 300 may employ whether the change request is equal to or greater than a predetermined ratio of the number of people included in information on the number of people scheduled to get on/off the route mobility device 108, as the change condition (S110).

The information on the number of people scheduled to get on/off may include the number of people calculated based on the getting-on/off request and stop change request of the first regular stop 114 received from at least one of the user devices 100a and 100b or the kiosk through which the request to get on/off in the transfer hub 102 is received.

The server 300 may estimate the total number of people who are scheduled to get on/off the route mobility device 108 at the first regular stop 114 based on the information on the number of people scheduled to get on/off, and calculate the number of people who desires to change the stop or permits the change based on the responses of the user devices 100a and 100b related to the change of the stop. The number of people who permits the change may be calculated based on the stop change request and a change allowance response message of the change stop from the user devices 100a and 100b without the change request.

The server 300 may determine whether to change the stop of the route mobility device 108, by checking whether the number of people who permits the change is equal to or greater than the predetermined ratio of the total number of people. The predetermined ratio may be equally set for all the route mobility device 108 and the regular stops 114 and 116 or may be differently set according to at least one of the route mobility device 108 or the regular stops 114 and 116. The predetermined ratio may be, for example, 50% or more of the total number of people. As another example, the predetermined ratio may be less than 50% according to the settings of the server 300, but may be a variable rather than a fixed value. As another example, the server 300 may receive user information from the user devices 100a and 100b having the change request, and the predetermined ratio may vary according to user profile information included in the user information. When there is a change request of the mobility device from handicap person such as elderly, pregnant woman or patient determined from the user profile information, a higher weight is given to the change request of the mobility device from handicap person compared to the other response. Therefore, even if the actual ratio of the change permission is less than 50%, the change condition may be satisfied. In contrast, when the server 300 receives a change disallowance response message from the mobility-handicap person, a higher weight is given to the disallowance response from the mobility-handicap person compared to the other responses. Therefore, even if the actual ratio of the change permission is equal to or greater than 50%, the change condition may not be satisfied.

If the change request is equal to or greater than the predetermined ratio of the number of people scheduled to get on/off, the server 300 may analyze information on the change stop according to the change request (S115).

The server 300 may check whether a single or a plurality of change stops 104, 116 and 118b is requested by the user devices 100a and 100b. When the single change stop is requested, the server 300 may proceed to step of determining the change stop. When the plurality of change stops is requested, the server 300 may analyze, for example, the number of requests of the user devices 100a and 100b for each change stop. As another example, the server 300 may generate change group information by grouping the requested change stops within a predetermined distance range and applying a weight which gradually decreases from the change group information of a maximum request to the change group information of a minimum request. As another example, the server 300 may receive the user profile information from the user devices 100a and 100b with the change request and give a higher weight to the change stop of the mobility device from handicap person compared to the other change stop.

Subsequently, the server 300 may determine the change stop according to the result of analysis, and transmit a message of the determined final change stop to all the user devices 100a and 100b scheduled to get on/off the route mobility device 108, the kiosk and the route mobility device 108 (S120).

When the single change stop is requested, the server 300 may determine the single change stop as a final change stop. As another example, the server 300 may determine a dynamic stop between the single change stop and the first regular stop 114 as a final change stop. The server 300 may determine a change stop between these stops or a dynamic stop close to the first regular stop 114 as a final change stop. In the above-described example, the final change stop may be arbitrarily assigned between these stops or may be designated as a preset dynamic stop. In addition, when the mobility-handicap person is included in users who have requested the change or respond to disallow the change, the server 300 may determine the final change stop based on the request or response of the mobility-handicap person.

When the plurality of change stops is requested, the server 300 may determine, for example, any one of the requested change stops 104, 116 and 118b as a final change stop. In this case, a stop having the maximum request among the requested change stops 104, 116 and 118b may be determined as a final change stop. As another example, the server 300 may determine any one of dynamic stops located between the plurality of requested change stops 104, 116 and 118b. Here, a dynamic stop adjacent to the change stop having the maximum request among the requested change stops 104, 116 and 118b may be designated as a final change stop. In contrast, the server 300 may set a dynamic stop, which is preset to be adjacent to the requested change stop, as a final change stop. As another example, the server 300 may determine a dynamic stop between the plurality of requested change stops 104, 116 and 118b, based on the change group information, to which the weight is given in step S115. In examples of the process of determining the final stop based on the plurality of requested change stops, the final change stop may be arbitrarily assigned between the plurality of requested change stops or may be designated as a preset dynamic stop. In addition, when the mobility-handicap person is included in users who have requested the change or respond to disallow the change, the server 300 may determine the final change stop based on the request or response of the mobility-handicap person. As another example, when the requested change stops 104, 116 and 118b of the people who are scheduled to get on and off the route mobility device 108 are located at a predetermined distance or more, the requested change stop of the people scheduled to get on may take precedence over the people scheduled to get off. This is to change the stop in a range predictable by the people scheduled to get on, because the people scheduled to get on cannot rapidly identify the change stop due to change to a stop which is not predicted by the people scheduled to get on. In addition, when there is a plurality of requested change stops of the people scheduled to get on, the server 300 may determine a final change stop by any one of the various examples described above.

Next, the server 300 may perform control such that the route mobility device 108, to which the message has been transmitted, stops at the final change stop (S125).

When the route mobility device 108 is human-operated, the server 300 may provide the route mobility device 108 with a route to the final change stop in the form of a visual map. When the route mobility device 108 is autonomously driven, the server 300 may transmit the location information of the final change stop to the route mobility device 108 and control the route mobility device 108 to move to the change stop.

Meanwhile, when the change request is less than the predetermined ratio of the number of people scheduled to get on/off, the server 300 may transmit a message disallowing the change of the stop to at least the first and second user device 100b and the route mobility device 108 (S130). In addition, the server 300 may transmit the message disallowing the change to the user device of the person scheduled to get on/off and the kiosk.

Subsequently, the server 300 may perform control the route mobility device 108, to which the message disallowing the change is transmitted, to stop at the final change stop (S135).

FIG. 7 is a flowchart illustrating a second detailed embodiment in a stop control method. FIG. 7 illustrates a detailed example related to the stop change request of FIG. 5 and the steps which are substantially the same as FIG. 6 are briefly described to avoid redundant description.

The first and second user devices 100b may transmit, to the route mobility device 108, a message requesting to change the first regular stop 114 to the other stops 104, 118b and 118c and stop at the other stops 104, 118b and 118c, and the server 300 may receive a message related to the stop change request through the route mobility device 108 (S205).

A first user may transmit the message requesting change to the other stops 104 and 118b using the first user device 100a in a state of getting on the route mobility device 108, and the server 300 may receive the message from the first user device 100a. The stop change request may be generated from at least one of getting-on/off designation information or shared mobility use information received from the first user device 100a.

A change request with a designated getting-off point is substantially the same as step S105 of FIG. 6 and thus a description thereof is omitted.

The stop change request based on shared mobility use information may be generated based on the shared mobility use information received from the first user device 100a. The shared mobility use information may be received from the first user device 100a, and may include at least one of real-time assignment and reservation information of the user for the shared mobility device provided in the shared mobility areas 110 and 112. The stop change request may be set to designate an entrance to approach the shared mobility areas 110 and 112 or the location of the vicinity thereof as the requested change stop, according to the type of the shared mobility device for transfer.

In addition, the second user may transmit a message requesting change to the other stops 104 and 118c using the second user device 100b while waiting in the transfer hub 102, and the server 300 may receive the message from the second user device 100b. In this case, the stop change request may be generated from at least one of getting-on/off designation information or transfer information received from the second user device 100b.

A change request with a designated getting-on point is substantially the same as step S105 of FIG. 6 and thus a description thereof is omitted. The stop change request based on the shared mobility use information may be generated based on the shared mobility use information received from the second user device 100b. In this case, the shared mobility use information may be based on at least one of a scheduled return request of a user for the shared mobility device provided in the shared mobility areas 110 and 112, use end information or use state information related to a shared mobility device having an imminent return time and approaching the vicinities of the shared mobility areas 110 and 112. Here, setting of the requested change stop according to designation and shared mobility use information may be substantially the same as the example of the first user device 100a.

Meanwhile, before the route mobility device 108 arrives at the first regular stop 114, a query message for inquiring whether to allow change of the stop may be provided to the user device which is getting on or is scheduled to get on the route mobility device 108 and the reception device of the transfer hub 102, such as the kiosk. The user device may transmit, to the server 300, a response to allow or disallow the change in response to the query message. Additionally, the server 300 may receive a message related to the above-described stop change request, by inquiring of the user device which has respond to allow the change about whether to request the change of the stop.

Next, the server 300 may determine whether the stop change request received from the first and second user devices 100b satisfies a change condition. In the present disclosure, similarly to step S110 of FIG. 6, the server 300 may employ whether the change request is equal to or greater than a predetermined ratio of the number of people included in information on the number of people scheduled to get on/off the route mobility device 108 as the change condition (S210).

If the change request is equal to or greater than the predetermined ratio of the number of people scheduled to get on/off, the server 300 may analyze information on the change stop according to the change request (S215).

Subsequently, the server 300 may determine the change stop according to the result of analysis, and transmit a message of the determined final change stop to all the user devices 100a and 100b scheduled to get on/off the route mobility device 108, the kiosk and the route mobility device 108 (S120). Next, the server 300 may perform control such that the route mobility device 108, to which the message has been transmitted, stops at the final change stop (S225).

Meanwhile, when the change request is less than the predetermined ratio of the number of people scheduled to get on/off, the server 300 may transmit a message disallowing the change of the stop to at least the first and second user device 100b and the route mobility device 108 (S230). Subsequently, the server 300 may perform control the route mobility device 108, to which the message disallowing the change is transmitted, to stop at the final change stop (S235).

Steps S210 to S235 are substantially equal to steps S110 to S135 of FIG. 6 and thus the description thereof is omitted. In addition, when the stop change request includes all the getting-on/off designation information, the transfer information and the shared mobility use information, the server 300 may perform the stop change method by a combination of FIGS. 6 and 7.

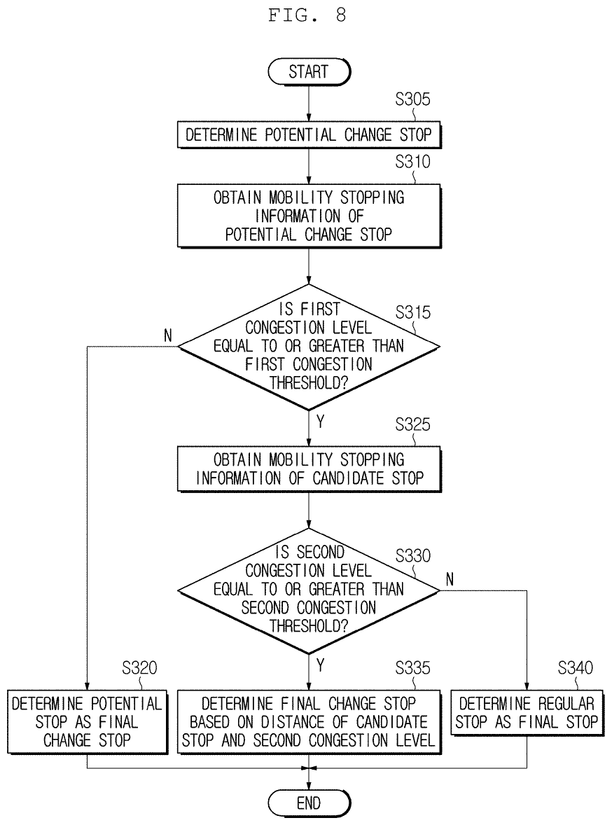

FIG. 8 is a flowchart illustrating a third detailed embodiment in a stop control method. FIG. 8 illustrates a modified example related to the process of determining the change stop, that is, steps S120 and S220, of FIGS. 6 and 7.

First, the server 300 may potentially determine the change stop according to the stop change request (S305), by performing steps S120 and S220. In the present disclosure, the potentially determined change stop may be referred to as a potential stop.

Next, the server 300 may predict a scheduled time when the route mobility device 108 will stop at the potential stop, and obtain stopping information of the mobility device which will stop at the potential stop at the scheduled stop time (S310).

The server 300 may obtain stopping information of the route mobility device 108 which will stop at the scheduled stop time at the potential stop and in a predetermined range thereof. In addition, the server 300 may obtain congestion information due to personal mobility or passersby at the scheduled stop time. The stop information may be received from the route mobility device 108 which uses the potential stop as a regular stop or designates the potential stop as the change stop. The congestion information may be generated, for example, based on image data of the potential stop before the scheduled stop time, average data of personal mobility and passersby collected in the past on a weekly or monthly basis.

Next, the server 300 may calculate a first congestion level of the potential stop at the scheduled stop time based on the stopping information and the congestion information, and determine whether the first congestion level is equal to or greater than a first congestion threshold (S315).

If the first congestion level is less than the first congestion threshold, the server 300 may determine the potential stop as a final change stop and transmit a change stop message (S320).

In contrast, if the first congestion level is equal to or greater than the first congestion threshold, the server 300 may select at least one stop other than the potential stop and the regular stop as a candidate stop, and obtain the mobility stopping information and congestion information of the candidate stop at the scheduled stop time (S325).

The candidate stop may include points located within a predetermined distance range of the potential stop or requested change stops corresponding to lower priority among the plurality of requested change stops, but is not limited thereto and variously settings may be possible.

Subsequently, the server 300 may determine whether a second congestion level of each candidate stop is equal to or greater than a second congestion threshold (S330). The second congestion threshold may be set to be lower than the first congestion threshold.

When there are candidate stops having the second congestion level less than the second congestion threshold, the server 300 may determine any one of the plurality of candidate stops as a final change stop based on a distance between the potential stop and the candidate stop and the congestion level of the candidate stop, and transmit the change stop message (S335).

For example, the server 300 may select a candidate stop closest to the potential stop from among all candidate stops with the congestion level less than a reference threshold or select a candidate stop having a low congestion level from among all candidate stops having a distance less than a reference distance.

When all the second congestion levels of the candidate stops are equal to or greater than the second congestion threshold, the server 300 may determine the regular stop as a final stop and transmit a change stop message, for user convenience and congestion reduction (S340). As another example, the server 300 may determine a potential stop according to the change request as a final change stop and transmit the message.

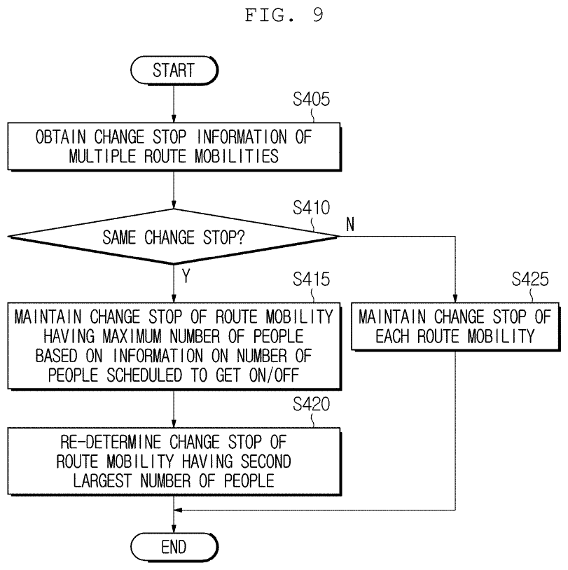

FIG. 9 is a flowchart illustrating a fourth detailed embodiment in a stop control method. FIG. 9 illustrates a modified example related to the process of determining the change stop, that is, steps S120 and S220, of FIGS. 6 and 7.

The server 300 may obtain change stop information of a plurality of route mobility devices 108 which will stop at the transfer hub 102 at the same time (S405). The change stop information may be related to the change stop determined in steps S120 and S220 for each route mobility device 108.

Next, the server 300 may determine whether at least two of the plurality of route mobility devices 108 designates the same change stop (S410). Here, the same change stop may correspond to the same point or a plurality of stops located within a predetermined distance range.

Upon determining that there is a plurality of same change stops, the server 300 may check a route mobility device 108 having a maximum number of people based on information on the number of people scheduled to get on/off at each change stop and determine that the route mobility device 108 having the maximum number of people maintains the change stop (S415). A message related to the maintained change stop may be transmitted by the server 300.

The information on the number of people scheduled to get on/off may include the number of people calculated based on the stop change request and the getting-on/off request of the regular stop received from at least one of the user devices 100a and 100b or the kiosk which receives the getting-on/off request in the transfer hub 102. Specifically, the number of people may be estimated by including the allowance or disallowance response and the change request of the user devices 100a and 100b and the kiosk in response to the query message inquiring about whether to allow the change of the stop. In addition, the information on the number of people scheduled to get on/off may include whether a user who requests the change is the mobility-handicap person, by referring to the user profile information from the user devices 100a and 100b, and the mobility-handicap person may be given a higher weight than the other users.

Next, the server 300 may re-determine the change stop of next-ranked route mobility device having in the number of people (S420).

The re-determined change stop may be, for example, a point located within a predetermined distance range of a first change stop or a requested change stop having a lower priority among the plurality of requested change stops, but is not limited thereto and various settings are possible.

Meanwhile, when all the plurality of route mobility devices 108 designates different change stops, the server 300 may maintain the change stop of each route mobility device 108 and transmit a message (S425).

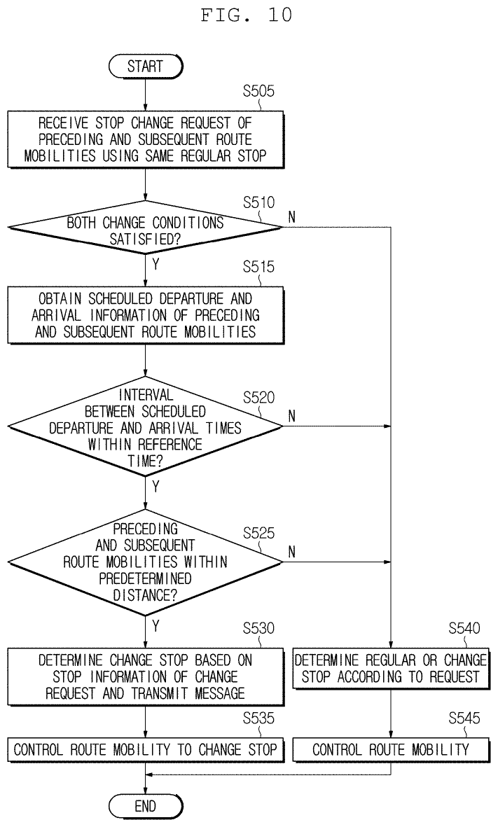

FIG. 10 is a flowchart illustrating control of a stop of preceding and subsequent route mobility devices stopping at the same regular stop. In the present disclosure, the steps which are substantially the same as FIGS. 6 and 7 are briefly described to avoid redundant description.

The transfer hub 102 may be set to enable mobility devices having relatively high transfer demand frequency and having different routes to use the same regular stop, for transfer convenience. Accordingly, the present disclosure relates to a method of determining the change stop when there is a stop change request from different route mobility devices with high transfer demand.

First, the server 300 may receive a stop change request for preceding and subsequent route mobility devices 108 using the same regular stops 114 and 116, from at least one of the user devices 100a and 100b or the kiosk (S505).

The preceding route mobility device may mean a route mobility device which arrives at the same regular stops 114 and 116 before the subsequent route mobility device 108. The stop change request is implemented substantially the same as in the steps S105 and S205 of FIGS. 6 and 7 and a description thereof is omitted.

Subsequently, the server 300 may determine whether stop change requests for the preceding and subsequent route mobility devices 108 respectively satisfy change conditions (S510).

Regarding to the determination of whether to satisfy the change condition, similarly to steps S110 and S210 of FIGS. 6 and 7, the server 300 may employ whether the change request is equal to or greater than a predetermined ratio of the number of people included in information on the number of people scheduled to get on/off each of the preceding and subsequent route mobility devices 108 as the change condition.

If the change condition is satisfied in both the preceding and subsequent route mobility devices 108, the server 300 may obtain scheduled departure information of the preceding route mobility device and the scheduled arrival information of the subsequent route mobility device (S515).

When the change condition relates to, for example, whether it is equal to or greater than the predetermined ratio of the number of people scheduled to get on/off, the server 300 may obtain the scheduled departure and arrival information when it is equal to or greater than the predetermined ratio of the number of people in each route mobility device. The scheduled departure and arrival information may include a scheduled departure and arrival time. In this case, the server 300 may obtain the location information of the preceding and subsequent route mobility devices and a distance from the transfer hub 102 from each route mobility device, and the server 300 may calculate a scheduled departure and arrival time. As another example, the server 300 may receive a scheduled departure and arrival time from each route mobility device.

Subsequently, the server 300 may determine whether an interval between the scheduled departure and arrival times of the preceding and subsequent route mobility devices 108 are within a reference time (S520).

If it is within the reference time, the server 300 may finally determine the change stop based on the preceding and subsequent change stops according to the change request and transmit a message of the finally determined change stop to all the user devices 100a and 100b scheduled to get on/off each route mobility device 108, the kiosk and the route mobility device 108 (S525).

The change stop may be finally determined based on potential change stops when a distance between potential change stops of the preceding and subsequent route mobility devices according to the request change is within a predetermined value. As another example, the change stop may be finally determined based on the potential change stops regardless of the distance between the potential change stops. In the above-described examples, the final change stop may be designated as any one of the potential change stops or a dynamic stop between the potential change stops. Based on at least one of information on the number of people scheduled to get on/off or user profile information obtained from the user devices 100a and 100b scheduled to get on/off each route mobility device 108, a higher weight may be given to any one of the potential change stop. The user profile information may be data including the mobility-handicap person.

Subsequently, the server 300 may perform control such that each route mobility device 108, to which the message is transmitted, stops at the final change stop (S530).

Meanwhile, if the change condition is not satisfied in at least one of the preceding and subsequent route mobility devices 108 in step S510 or if the interval between the scheduled departure and arrival times exceeds the reference time in step S520, the server 300 may determine the stop of each route mobility device 108 to be a corresponding regular stop or a corresponding change stop according to the change request (S535). Subsequently, the server 300 may transmit a message related to the determined stop to each route mobility device, the user devices 100a and 100b and the kiosk, and control stopping of the route mobility device 108 (S540 and S545).

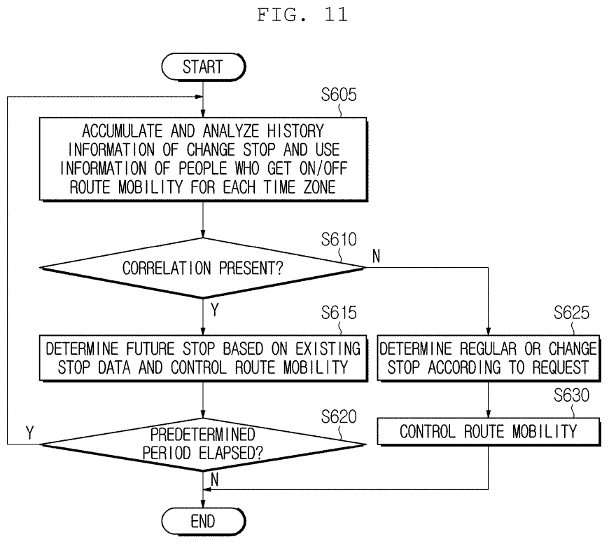

FIG. 11 is a flowchart illustrating determination of a stop based on history information of a change stop and user information of a route mobility device.

After the route mobility device 108 stops at the final change stop by transmitting the change stop message of FIGS. 5 to 7, the server 300 may accumulate and analyze the use information of people who get on/off the route mobility device 108 and the history information of the change stop used by the route mobility device 108 for each time zone (S605).

The use information of people who get on/off the route mobility device 108 may be generated from information on users who are checked to get on/off from at least one of the user devices 100a and 100b or the route mobility device 108. The use information of people who get on/off may include at least one of getting-on/off designation information, transfer information or shared mobility use information of the user.

Next, the server 300 may determine whether there is a correlation between the route mobility device 108 and the change stop for each specific period as the result of analysis (S610). The specific period may be, for example, a specific day of the week or time zone in a period of one week.

Subsequently, if there is a correlation, the server 300 may determine a potential stop based on existing stop data, transmit a message of the determined stop to the route mobility device 108, the user devices 100a and 100b, the kiosk and the mobility management server 300, and perform control such that the route mobility device 108 stops at the stop (S615).

For example, if there is a correlation in which the number of times the route mobility device 108 uses the same change stop at a specific day of the week and a specific time zone is equal to or greater than a predetermined number, the server 300 may determine a new stop of the route mobility device 108 to be the change stop during a predetermined period.

After the change stop is used as a stopping point during the predetermined period, the server 300 may repeat steps S605 to 615. This is because, even if the change stop is used along with the potential regular stop, the stop may vary even at a specific time zone by the stop change request of the user.

Meanwhile, if there is no correlation, the server 300 may determine the regular stops 114 and 116 or the change stops 118a to c to be the stopping point of the route mobility 108 in response to the stop change request, as shown in FIGS. 5 to 7 (S625), and perform control such that the route mobility device 108 stops at the determined stop (S630).

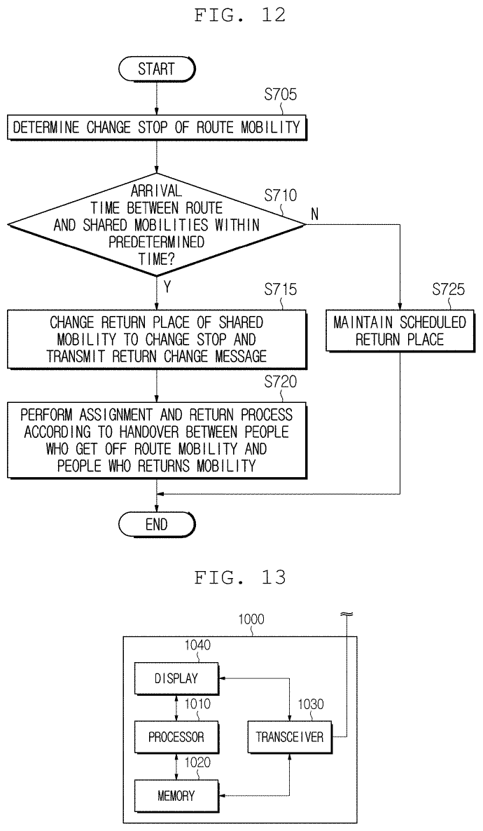

FIG. 12 is a flowchart illustrating determination of a return place of a shared mobility device based on stop information of a route mobility device.

As shown in FIG. 7, a change stop message based on shared mobility use information may be transmitted (S705).

When the scheduled arrival time between the route mobility device 108 and the shared mobility device is within a predetermined time (Y of S710), the server 300 may perform control such that a shared mobility device which is requested by a user who rides on the route mobility device 108 and is used by another person is returned, and transmit a return change message to the shared mobility device and the user device using the route mobility device 108 (S715). Subsequently, by handover between the person who gets off the route mobility device 108 and the person who returns the shared mobility device, the server 300 may perform a suitable assignment and return process (S720). In the present disclosure, when the change stop is determined to be a point different from the shared mobility area, the above-described process is more useful.

When the scheduled arrival time interval exceeds the predetermined time (N of S710), the server 300 may maintain returning to the scheduled return place of the transfer hub 102, for example, the shared mobility areas 110 and 112 (S725).

FIG. 13 is a diagram illustrating the configuration of a device according to an embodiment of the present disclosure. Referring to FIG. 13, the device may include at least one of the above-described mobility device, device, server or RSU. That is, the device may perform communication with another device and may interwork with another device and is not limited to the above-described embodiments. For example, the device 1000 may include at least one of a processor 1010, a memory 1020, a transceiver 1030 or a display 1040, for the above operation. That is, the device may include components necessary to perform communication with another device or display a mutual data processing result. In addition, for example, the device may include other components in addition to the above-described components. That is, the device may include the above-described device to perform communication with another device, but is not limited thereto and may operate the above description.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method of controlling a stop of a mobility device for a stop control management system implemented by a computing device, the method comprising:
receiving a stop change request of a route mobility device from a user device;
determining whether the stop change request satisfies a change condition;
determining a change stop of the route mobility device based on the stop change request when the change condition is satisfied; and
transmitting a change stop message to the route mobility device and at least one of the user device or a mobility device used by a user.

2. The method of claim 1, wherein the stop change request is generated based on at least one of getting-on/off designation information of a getting-on/off stop received from a user device of a person scheduled to get on/off the route mobility device, transfer information of a transfer route mobility device received from the user device or shared mobility use information received from the user device.

3. The method of claim 1, wherein the determining whether the stop change request satisfies the change condition comprises determining that the change condition is satisfied when the stop change request is equal to or greater than a predetermined ratio of a number of people included in information on the number of people scheduled to get on/off the route mobility device.

4. The method of claim 3, wherein the number of people is calculated based on a getting-on/off request of a regular stop received from at least one of the user device or a reception device which receives a getting-on/off request in a mobility transfer hub, in which the route mobility device stops, and the change request.

5. The method of claim 4, wherein whether the stop change request is equal to or greater than the predetermined ratio is determined based on the change request, an allowance response message of a change stop from a user device without the change request and the number of people scheduled to get on/off.

6. The method of claim 1, wherein the determining the change stop comprises determining any one of a preset dynamic stop adjacent to a requested change stop or a dynamic stop adaptively selected for a plurality of requested change stops, based on change stop information in the change request.

7. The method of claim 6, wherein the determining the dynamic stop between the plurality of requested change stops comprises determining the dynamic stop between the change stops by generating change group information by grouping a plurality of change stops within a predetermined distance range and applying a weight which gradually decreases from change group information of a maximum request to change group information of a minimum request.

8. The method of claim 6, wherein the change stop is determined to be a dynamic stop adjacent to a regular stop of the route mobility device among the dynamic stops.

9. The method of claim 1, wherein the determining the change stop comprises:
determining a potential change stop based on the change request;
obtaining mobility stopping information at the potential change stop; and
determining the potential change stop as a final change stop based on a congestion level of the potential change stop according to the mobility stopping information.

10. The method of claim 9, wherein the determining the potential change stop as the final change stop comprises:
selecting a plurality of candidate stops and obtaining mobility stopping information of the candidate stops, when the congestion level of the potential change stop is equal to or greater than a first congestion threshold; and
determining any one of the plurality of candidate stops as the final change step, based on distances between the potential change stop and the candidate stops and congestion levels of the candidate stops, when the congestion levels of the candidate stops according to the mobility stopping information are equal to or less than a second congestion threshold.

11. The method of claim 1, wherein the determining the change stop comprises:
when change stops of a plurality of route mobility devices are the same, maintaining a change stop of a route mobility device having a maximum number of people based on information on the number of people scheduled to get on/off each route mobility device, and
re-determining a change stop of a next-ranked route mobility device in the number of people.

12. The method of claim 1, wherein the determining the change stop comprises:
when different stop change requests of preceding and subsequent route mobility devices using the same regular stop are received, determining a final change stop based on a scheduled departure time of the preceding mobility device, a scheduled arrival time of the subsequent mobility device and preceding and subsequent change stops according to the change request.

13. The method of claim 12, wherein the final change stop is determined such that the change stops of the preceding and subsequent route mobility devices are the same, when an interval between the scheduled departure and arrival times is within a predetermined time and a distance between the preceding and subsequent change stops is within a predetermined value.

14. The method of claim 1, further comprising, after transmitting the change stop message:
analyzing history information of the change stop and use information of people who get on/off the route mobility device for each time zone; and
determining a new stop based on existing stop data when there is a correlation between the history information and the use information of the people who get on/off.

15. The method of claim 1, further comprising:
after transmitting the change stop message, performing control such that a shared mobility device is returned to the change stop, when a scheduled arrival time between the route mobility device and the shared mobility device is within a predetermined time.

16. A server for controlling a stop of a mobility device, the server comprising:
a transceiver configured to transmit and receive a signal; and
a processor configured to control the transceiver,
wherein the server is configured to:
receive a stop change request of a route mobility device from a user device;
determine whether the stop change request satisfies a change condition;
determine a change stop of the route mobility device based on the stop change request when the change condition is satisfied; and
transmit a change stop message to the route mobility device and at least one of the user device or a mobility device used by a user.

17. The server of claim 16, wherein the stop change request is generated based on at least one of getting-on/off designation information of a getting-on/off stop received from a user device of a person scheduled to get on/off the route mobility device, transfer information of a transfer route mobility device received from the user device or shared mobility use information received from the user device.

18. The server of claim 16, wherein, in determining whether the stop change request satisfies the change condition, it is determined that the change condition is satisfied, when the stop change request is equal to or greater than a predetermined ratio of a number of people included in information on a number of people scheduled to get on/off the route mobility device.

19. The server of claim 16, wherein, in determining the change stop, any one of a preset dynamic stop adjacent to the requested change stop or a dynamic stop adaptively selected for a plurality of requested change stops is determined based on change stop information in the change request.

20. A management system implemented by a computing device to perform a mobility stop control process, the management system comprising:
a server configured to operate the management system;
at least one user device registered in the management system; and
at least one route mobility device registered in the management system,
wherein the server is configured to:
receive a stop change request of a route mobility device from a user device;
determine whether the stop change request satisfies a change condition;
determine a change stop of the route mobility device based on the stop change request when the change condition is satisfied; and
transmit a change stop message to the route mobility device and at least one of the user device or a mobility device used by a user.
